(19) United States
(12) Patent Application Publication
(10) Pub. No.: US 2009/0245635 A1
(43) Pub. Date: Oct. 1, 2009

(54) SYSTEM AND METHOD FOR SPAM DETECTION IN IMAGE DATA

(76) Inventors: Erez YEHEZKEL, Haifa (IL); Uzi (Ezra) YEHEZKEL, Meuhad (IL)

Correspondence Address: Pearl Cohen Zedek Latzer, LLP, 1500 Broadway, 12th Floor, New York, NY, 10036, US

(21) Appl. No.: 12/055,812

(22) Filed: Mar. 26, 2008

(51) Int. Cl. G06K 9/34

(52) U.S. Cl. 382/171

(57) ABSTRACT

A method of detecting and processing messages that include SPAM images by comparing a concentration of grayscale frequencies in a subject image to known concentration of grayscale frequencies in other SPAM messages. The image may be further evaluated for classification as SPAM by evaluating a measure of randomness of pixels having non-white markings to determine if random markings were added to the image.

### FIELD OF THE INVENTION

The present invention relates generally to detecting unsolicited or unwanted electronic mail communication, commonly known as SPAM.

### BACKGROUND OF THE INVENTION

Unsolicited or unwanted electronic mail communications, commonly known as SPAM, may create a distraction for email users, expose computer networks to viruses and clog email delivery or reception programs. Designating a message as SPAM may allow the message to be intercepted before it reaches an intended recipient or before it is opened.

Detection of SPAM has focused on detecting text that may be included or embedded in a message. Some detectors were able to detect such images by using a stamp mark such that if an image appears in several received messages the message may be classified as SPAM. Spammers have overcome this detection by altering a color histogram of an image that is included in a message. Spammers may randomly change some pixels values in such way that the stamp of the image will appear different each time it is published. Spammers, or senders of SPAM, may further avoid detection by including graphics or images into SPAM messages that may allow SPAM to pass through commonly available filters or detectors.

### SUMMARY OF THE INVENTION

Some embodiments of the invention may include a method of determining whether an image is SPAM, where such method includes quantifying a grayscale value of a series of pixels in an image that may be included in a message, deriving a concentration value of the grayscale values in the series of pixels, comparing the derived concentration value to a concentration value that is associated with SPAM images, and processing a message classified as SPAM in accordance with a pre-defined procedure.

In some embodiments, the method may include applying a two dimensional fourier transform function to the grayscale values of the series of pixels.

In some embodiments, deriving concentration values includes transforming the grayscale values of the series of pixels into a frequency graph of the values.

In some embodiments, the method may include segmenting the image into a series of pixels.

In some embodiments, the method may include collecting concentration values of several images, where such several images are SPAM images.

In some embodiments, the method may include detecting non-white pixels in a series of pixels, and calculating a measure of randomness of the detected non-white pixels in the series of pixels.

In some embodiments, the method may include calculating a number of non-white pixels that are surrounded on at least three sides by white pixels.

Some embodiments of the invention may include a method of determining whether an image is a SPAM image by comparing a frequency mode of transformed grayscale values of pixels in the image to a frequency mode of transformed grayscale values of pixels in several SPAM images, and processing a SPAM image in accordance with a pre-defined procedure such as deletion, storage of the message in a secure location or prevention of the message from reaching an addressee.

Some embodiments of the invention may include classifying an image as SPAM by detecting a non-white mark in a first pixel of a series of pixels and in several pixels adjacent to the first pixel, detecting a non-white mark in a second pixel of the series of pixels and in several pixels adjacent to the second pixel, calculating a measure of randomness of the non-white mark of the first pixel and the several pixels adjacent to the first pixel, and of the second pixel and of several pixels adjacent to the second pixels, and comparing the measure of randomness to a pre-defined measure or randomness. In some embodiments, if the message is classified as SPAM, the message may be processed in accordance with a pre-defined procedure.

In some embodiments, detecting a non-white mark in pixels adjacent to the first pixel includes detecting non-white marks in up to eight pixels adjacent to the first pixel.

In some embodiments, calculating a measure of randomness includes calculating a number of dark pixels that are surrounded on at least three sides by non-dark pixels.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1A is an image, and FIG. 1B is a concentration diagram of grayscale frequencies of the image in accordance with an embodiment of the invention;

FIG. 2A is an image that may be included in a SPAM message, and FIG. 2B is a sample concentration diagram of grayscale frequencies of the SPAM image, in accordance with an embodiment of the invention;

FIG. 3 is a matrix overlaid on random markings such as those present an image in accordance with an embodiment of the invention; and

FIG. 4 is a flow chart of a method in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF THE INVENTION

In the following detailed description, numerous specific details are set forth in order to provide a thorough understanding of embodiments of the invention. However it will be understood by those of ordinary skill in the art that embodiments of the invention may be practiced without these specific details. In other instances, well-known methods, procedures, and components have not been described in detail so as not to obscure the embodiments of the invention.

Unless specifically stated otherwise, as apparent from the following discussions, it is appreciated that throughout the specification, discussions utilizing terms such as “selecting,” “processing,” “computing,” “calculating,” “determining,”, “comparing” or the like, may refer to the actions and/or processes of a computer, computer processor or computing system, or similar electronic computing device, that may manipulate and/or transform data represented as physical, such as electronic, quantities within the computing system's registers and/or memories into other data similarly represented as physical quantities within the computing system's memories, registers or other such information storage, transmission or display devices. In some embodiments processing, computing, calculating, determining, and other data manipulations may be performed by one or more processors that may in some embodiments be linked.

The processes and functions presented herein are not inherently related to any particular computer, imager, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein. While in some embodiments, processes described herein may be applied to email communications, embodiments of the invention may be used in other electronic communication mediums such as electromagnetic wave communications such as radio, television or cellular communication systems. In some embodiments, processes described herein may be applied to the detection, analysis or classification of other communications or data transmissions over an electronic or other network.

In some embodiments, instructions may be stored on a medium such as a mass data storage medium, and such instructions, when executed by a processor, may perform an embodiment of the invention.

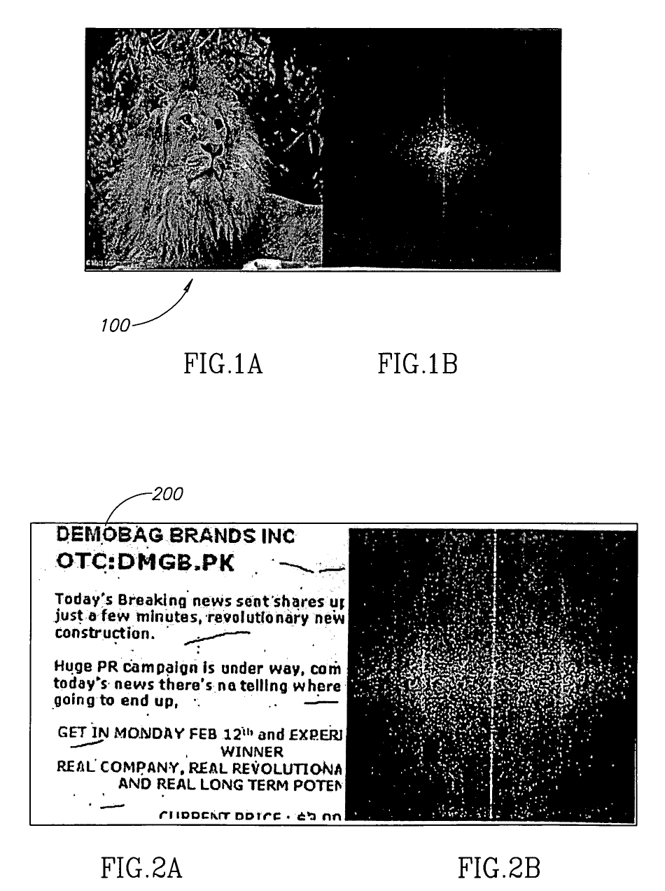

Reference is made to FIG. 1, which illustrates a sample of an image and a concentration diagram or frequency mode study of the image in accordance with an embodiment of the invention. A concentration diagram or frequency mode study of an image is a plot of the distribution of the frequency of colors or gray scale pixels about the image. In some embodiments, an image 100 may be, for example, included in or transmitted with an electronic communication, such as, for example, an e-mail, and may be divided into a series of pixels. For example, the data that may be included in a transmitted image may be loaded into a two dimensional array or matrix of, for example, 256×256 cells representing, for example, the pixels. Other matrix sizes may be used. In some embodiments, image data may be loaded directly into a matrix of pixels or data about the pixels directly from the image data that was transmitted or included in the electronic communication. In some embodiments, a grayscale or other measurement of the color or shading intensity or shades of gray of one, most all or a series of pixels in the matrix may be measured, quantified and recorded, such that a grayscale reading is associated with each pixel. In some embodiments, as many as 256 shades of gray may be included in the scale of intensities to be measured. In some embodiments, the intensities of red, green and blue shades appearing in a pixel may be used to calculate a grayscale of a pixel. Other grayscale units may be used.

In some embodiments, a two dimensional transform function such as, for example, a Fast Fourier Transform (FFT) function may be applied to the grayscale readings of a series of pixels, such as all of the pixels of an image 100. A two dimensional transform function is applied to the grayscale readings to access the geometric characteristics of a spatial domain image. The image in the FFT domain is decomposed into its sinusoidal components to more easily examine and process certain frequencies of the image. A further explanation of the use of the FFT may be found at http://homepages.inf.ed.ac.uk/rbf/HIPR2/fourier.htm In some embodiments, a two dimensional FFT may be implemented as two consecutive one-dimensional Fourier Transforms, such as first in the x direction and then in the y direction, or vice versa. Other functions and other implementations may be used. In some embodiments, the FFT may be expressed as follows:

F₁(u, y)=∫f(x, y)exp(−2π[ux])dx

F(u, v)=∫F₁(u, y)exp(−2π[vy])dy

A concentration study or frequency mode of the image 100, as appears in FIG. 1B, may be plotted. As can be observed in FIG. 1B, the concentration study of image 100 exhibits a high level of concentration of the pixels around a center point of the graph. Empirical analysis of images of objects (as opposed to SPAM images), as are frequently sent over electronic medium, supports a tendency of such images to exhibit high concentration levels of transformed grayscale frequencies. One explanation for the high concentration of SPAM images is the attempt of senders of SPAM to get around detectors of SPAM by adding stray marks or dots into an image. These stray marks have distinct frequency characteristics.

Reference is made to FIG. 2A, an exemplary image that may be included in a SPAM message, and to FIG. 2B, a concentration study of grayscale frequencies of the SPAM image, in accordance with an embodiment of the invention. In some embodiments, image 200 may be divided into pixels, which may then be loaded into a matrix. Grayscale measures for the pixels may be quantified for one pixel, some pixels, a series of pixels or all of the pixels in the matrix, and such grayscale measures may be associated with the respective pixels in the matrix. A function, such as an FFT, may plot or graph a concentration study of the grayscale frequencies of pixels in the matrix. As can be seen in FIG. 2B, the transformed frequencies of an exemplary SPAM image 200 supports a tendency of low or polarized concentration results, which differ markedly from the concentration result of image 100.

In some embodiments, exemplary images from SPAM messages may be collected, and concentration levels of grayscale frequencies may be calculated for such collected sample to establish a pre-defined base line of concentration levels that are associated with SPAM images. A comparison of concentration levels of other images may then be made to this base line or pre-defined level of concentration that is known to be associated with SPAM. In some embodiments, a discrete correlation between an image and a collection of representative frequency matrices of SPAM images may be calculated. The return value may be the average correlation values, having a float point of between, for example, 0 and 1, and such value may reflect a proximity or similarity of a given image to the representative SPAM images. Other methods of comparison are possible. Such a correlation may be expressed as follows

$${n}_{1} = {\sum }_{i = 0}^{n} {M}_{[ i ]}^{A} \cdot {M}_{[ i ]}^{B}$$

$${n}_{2} = {\sum }_{i = 0}^{n} {( {M}_{[ i ]}^{B} )}^{2}$$

$$correlate = \vert \frac{{n}_{1}}{{n}_{2}} \vert \cdot 100 ,$$

where M^{A} is the given image frequency, and M^{B} is one of the base SPAM frequency mode matrix results.

In some embodiments, if a concentration study of an image yields, for example, a 90% correlation with concentration study of exemplary SPAM images, the image may be assumed to be SPAM. Other figures or pre-defined correlations may be used as the basis for concluding that an image is part of a SPAM message.

In many cases, senders of SPAM include random markings within the SPAM image, as shown in FIG. 2A. Some senders of SPAM may include such random markings to avoid conventional SPAM detection. In some embodiments, random markings or noise in an image may be used as an indicator that a message is to be considered SPAM.

In some embodiments, some, all or a series of pixels in an image may be plotted onto a matrix. For one, some or all of the coordinates on matrix, an evaluation may be made as to whether a dark or non-white mark is present in such coordinate, and in some or all of its adjacent pixels. The presence of such marks in a coordinate and in some or all of its adjacent pixels may be plotted, and a measure of the randomness of the coordinates with and/or without such non-white marks may be measured. In some embodiments, the adjacent pixels to be evaluated may include the pixels on all four sides of the subject pixel as well as the diagonally adjacent pixels, such that for each pixel in a series, eight adjacent pixels are evaluated for the presence or absence of non-white markings. A high degree of randomness of such non-white marks in a series of pixels and their adjacent neighbors may be deemed an indicator of SPAM, or may be used as a conformation of a suspicion of SPAM.

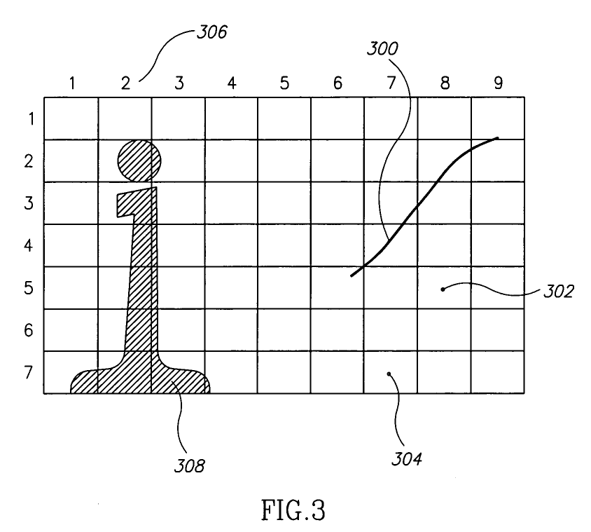

Reference is made to FIG. 3, which shows a matrix overlaid on a letter ‘i’ and on random markings that may be present in an image. For example, the dark or non-white markings produced by the letter ‘i’ 308 in the left side of matrix 306 exhibit a high degree of non-randomness. This may be indicated by the presence of substantial darkened portions over a series of pixels in column 2, column 3 and row 7, as well the absence of markings in a series of pixels in columns 1 and 4. By contrast, the dark markings 300, 302 and 304 on the right side of matrix 306 may be considered to display a high degree of randomness. This may be indicated by the presence of a dark or non-white mark in only a brief series of column 7 and 8 pixels, and in a single pixel in the lower portions of columns 7 and 8, as well as in the absence of markings in the pixels adjacent to those dark markings 300, 302 and 304.

In some embodiments, a measure of the randomness of dark pixels may be calculated by counting pixels that are surrounded on four sides, or on three or more sides, by non-dark pixels, and if such number exceeds a particular threshold per given area of the image, then the image may be suspected or categorized as SPAM. In some embodiments, a measure of randomness or of conformity to a random function may be applied to non-white pixels in an image to determine if such non-white pixels are randomly placed in an image. A high degree of randomness of the non-white pixels may be grounds for suspicion that the non-white pixels were added to the image as dirt to confuse a SPAM detection program.

Detection of a high degree of randomness may be used as a further indicator of SPAM messages.

Some embodiments may detect a presence of similar grayscale values in a series of pixels rather than just limiting the detection to dark or non-white values of pixels. Such similar grayscale values in a series of pixels may indicate a continuous line extending through such pixels.

In some embodiments, once a message has been categorized as SPAM, a server, gateway or filter that may be connected to or associated with a recipient computer or addressee of the message may block the transmission of the message to the inbox or other message receiving system that may also be associated with the recipient computer. In some embodiments, a message categorized as SPAM may be isolated or stored in secure area so that the contents of the message are not exposed to a network or other sensitive area. In some embodiments, the SPAM message may be deleted.

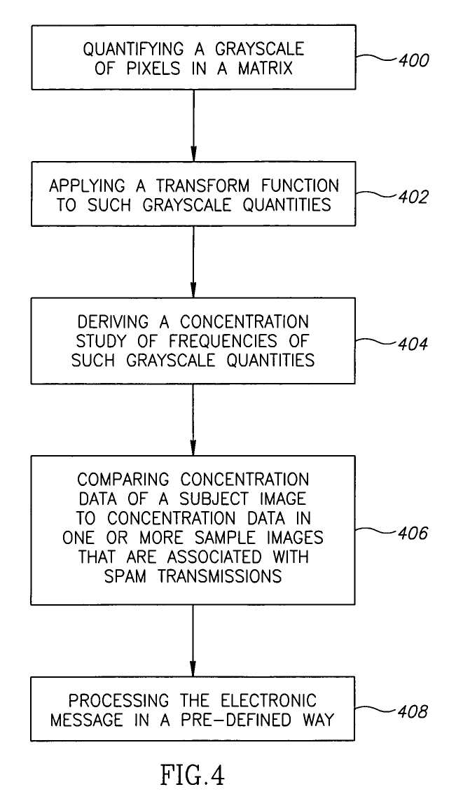

Reference is made to FIG. 4, a flow diagram in accordance with an embodiment of the invention. In some embodiments, image data may be input into a memory or processor. Image data may be loaded directly from image data that is transmitted over an electronic network, or may, for example, be scanned and broken or segmented into pixels. The image data may be loaded into a two dimensional array or matrix. In block 400, a grayscale measure of pixels may be quantified and associated with such pixels in the matrix. In block 402, a transform or other function, such as an FFT may be applied to the grayscale measures associated with the pixels in the matrix. In block 404, a concentration study of the grayscale frequencies may be plotted, and a measure of the concentration values of the plotted data may be quantified. In block 406, a comparison may be made between the concentration data of a subject image and the concentration data in one or more sample images that are associated with SPAM transmissions. A high degree of correlation may indicate that the subject image is to be classified as part of a SPAM message. In block 408, a message that is categorized as SPAM may be filtered out of a stream or list of messages to be sent to a user, isolated, stored in a secure area away from a network, deleted, marked as suspect or otherwise associated with an indication that the message may be a SPAM message. In some embodiments, a message that is categorized as SPAM may be processed in accordance with a predetermined policy.

In some embodiments, a positive comparison of a measure of concentration may be taken as a suspicion of SPAM in a message. A further study of the image may evaluate the randomness of gray or non-white markings in a series of pixels. A positive result on such further study may then confirm the suspicion of the positive result in the first test, and the message may be subject to a pre-defined policy to isolate, delete or prevent the message from being delivered to a user or addressee.

It will be appreciated by persons skilled in the art that embodiments of the invention are not limited by what has been particularly shown and described hereinabove. Rather the scope of at least one embodiment of the invention is defined by the claims below.

We claim:

1. A method of filtering electronic communications containing, comprising:
quantifying a grayscale value of a series of pixels in said image;
deriving a concentration value of said grayscale values in said series of pixels;
comparing said derived concentration value to a concentration value that is associated with a SPAM image;
determining based upon said comparison of said derived concentration value with said SPAM-associated concentration value whether said image is SPAM; and
processing said electronic communication containing said SPAM image in accordance with a predetermined policy.

2. The method of claim 1, wherein said deriving comprises applying a two dimensional fourier transform function to said grayscale values of said series of pixels.

3. The method of claim 1, wherein said deriving said concentration value comprises transforming said grayscale values of said series of pixels into a frequency graph of said values.

4. The method of claim 1, further comprising segmenting said image into said series of pixels.

5. The method of claim 1, further comprising collecting concentration values of a plurality of images, said plurality of images included in said SPAM image.

6. The method of claim 1, further comprising:
detecting non-white pixels in said series of pixels; and
calculating a measure of randomness of said detected non-white pixels in said series of pixels.

7. The method of claim 6, wherein said detecting comprises calculating a number of non-white pixels surrounded on at least three sides by white pixels.

8. A method of determining whether an image is a SPAM image comprising:
comparing a frequency mode of transformed grayscale values of pixels in said image to a frequency mode of transformed grayscale values of pixels in a plurality of SPAM images; and
upon a determination that said image is a SPAM image, applying a pre-defined procedure to a message in which said image is included.

9. The method as in claim 8, further comprising applying a fourier transform function to said greyscale values to derive said frequency mode.

10. A method of classifying an image as SPAM comprising:
detecting a non-white mark in a first pixel of a series of pixels and in a plurality of pixels adjacent to said first pixel of said series of pixels;
detecting a non-white mark in a second pixel of said series of pixels and in a plurality of pixels adjacent to said second pixel of said series of pixels;
calculating a measure of randomness of said non-white mark in said first pixel and said plurality of pixels adjacent to said first pixel, and in said second pixel and in said plurality of pixels adjacent to said second pixel;
comparing said measure of randomness to a pre-defined measure or randomness; and
upon a determination that said measure of randomness exceeds a pre-defined level, processing a message that includes said image in accordance with a pre-defined procedure.

11. The method as in claim 10, wherein said detecting said non-white mark in said plurality of pixels adjacent to said first pixel comprises detecting said non-white marks in eight pixels adjacent to said first pixel.

12. The method as in claim 10, wherein said calculating said measure of randomness comprises calculating a number of dark pixels that are surrounded on at least three sides by non-dark pixels.
